(19) United States
(12) Patent Application Publication
(10) Pub. No.: US 2017/0043751 A1
(43) Pub. Date: Feb. 16, 2017

(54) WHEEL CHOCK WITH RECESSED GRIPPING MEMBER

(71) Applicant: Buyers Products Company, Mentor, OH (US)

(72) Inventors: Mark Saltzman, Gates Mills, OH (US); Dave Zelis, Brecksville, OH (US); Scott Moorman, Concord Twp., OH (US)

(21) Appl. No.: 15/234,504

(22) Filed: Aug. 11, 2016

Related U.S. Application Data
(60) Provisional application No. 62/203,612, filed on Aug. 11, 2015.

(51) Int. Cl. B60T 3/00

(52) U.S. Cl. CPC B60T 3/00

(57) ABSTRACT

A wheel chock having a wedge-shaped body and a recessed gripping member is provided. The wedge-shaped body includes a bottom surface for engaging the ground, a front inclined wheel engaging surface, a back surface opposite the front inclined surface, and opposite upright side surfaces. At least one of the opposite upright side surfaces has a recess, and the gripping member is disposed in the recess. The gripping member does not substantially protrude beyond the upright side surface having the recess for enabling an improvement in compact packaging and shipping costs associated with the wheel chock.

### FIELD OF INVENTION

The present invention relates generally to wheel chocks, and more particularly to wheel chocks having gripping members.

### BACKGROUND

A wheel chock is generally known as a wedge of sturdy material placed against a parked vehicle's wheel to prevent movement of the vehicle. Wheel chocks are used with a wide variety of vehicles, including aircraft, train cars, mining trucks, tractor trailers, and automobiles. For ease of handling, wheel chocks may include a bar in a recess in a back surface of the chock. For facilitating removal, wheel chocks may include a gripping member, such as a handle or attachment loop, that protrudes from the wheel chock and is grippable by the user or is attachable to a rope or cable. Gripping members protruding from the wheel chock take up additional packaging space and may damage the shipping box, which is a major issue for retailers selling such products.

### SUMMARY OF INVENTION

The present invention provides a wheel chock having a gripping member disposed in a recess in a side wall of the wheel chock for enabling improvements in the handling, safety, and/or shipping costs associated with the wheel chock.

According to an aspect of the invention, a wheel chock for placement on the ground to engage a wheel of a vehicle includes a wedge-shaped body and a gripping member. The wedge-shaped body has a bottom surface for engaging the ground, a front inclined wheel engaging surface extending upwardly from the bottom surface, a back surface extending upwardly from the bottom surface and being opposite the front inclined surface, and opposite upright side surfaces each extending upwardly from the bottom surface and extending between the front inclined wheel engaging surface and the back surface. At least one of the opposite upright side surfaces has a recess, and the gripping member is disposed in the recess. The gripping member preferably does not protrude beyond the upright side surface having the recess for enabling an improvement in compact packaging and shipping costs associated with the wheel chock.

Embodiments of the invention may include one or more of the following features. In particular, the recess in the upright side surface may include recessed surfaces extending inwardly from the upright side surface. The recessed surfaces may include opposing recessed side surfaces, and the gripping member may be formed as a bar extending from one of the recessed side surfaces to the opposing recessed side surface.

In another embodiment, the opposing recessed side surfaces may include opposing upper and lower recessed side surfaces, and opposing lateral recessed side surfaces that are adjacent to and extend between the upper and lower recessed side surfaces. The respective recessed side surfaces may be connected by a recessed back surface. The gripping member may extend from one of the recessed side surfaces to the opposing recessed side surface, such as between opposing lateral recessed side surfaces. The gripping member may be spaced from the respective adjacent recessed side surfaces, such as the opposing upper and lower recessed side surfaces, and may also be spaced from the recessed back surface for enabling a user to grip the bar for manipulating the wheel chock.

In yet another embodiment, the gripping member may be disposed in the recessed back surface and extend outwardly from the recessed back surface.

Further optional features include the gripping member being selected from the group consisting of: eyebolt, u-bolt, ball-head bolt, hook, loop, ring, and post.

In another embodiment, the gripping member may be attached to the wheel chock, or the gripping member may be integrally formed and unitary with the wheel chock.

In an embodiment, the recess may be formed in various shapes and configurations, such as dish-shaped, hemispherical, prismatic, pyramidal, cylindrical, conical, and frustum-shaped.

In yet another embodiment, the recess may have a length between 1 inch to 6 inches, a width between 1 inch to 6 inches, and a depth between 1 inch to 3 inches for enabling a person to grip the gripping member and/or wheel chock by the recessed surfaces.

In an embodiment, the other one of the opposite upright side surfaces may have a second recess with a second gripping member disposed therein, the second gripping member not protruding beyond the other one of the upright side surfaces.

According to another embodiment, the front inclined wheel engaging surface has a plurality of traction members for enabling engagement and traction with the wheel.

In still another embodiment, the back surface of the wheel chock may also be an inclined wheel engaging surface having traction members for enabling engagement and traction with the wheel.

Further optional features include the bottom surface having grooves, treads, recesses and/or protrusions for enabling engagement and traction with the ground.

In another embodiment, the bottom surface may have an opening for accessing an internal hollow of the wheel chock and/or for reducing the mass of the wheel chock.

According to another aspect of the invention, a wheel chock for placement on the ground and being engageable with a wheel includes a gripping member and a hollow wedge-shaped body. The hollow wedge-shaped body is formed by walls including opposite inclined front and back wheel engaging walls each having a bottom surface for engaging the ground and an inclined surface for engaging the wheel; and opposite upright sidewalls extending between the opposite front and back wheel engaging walls, wherein the opposite upright sidewalls each have a bottom surface and an outer side surface. At least one of the opposite upright sidewalls has a recess and the gripping member is disposed in the recess, wherein the gripping member does not substantially protrude beyond the outer side surface of the opposite upright sidewall having the recess.

According to an embodiment, additional optional features may include the recess having recessed surfaces extending into the upright sidewall, where the recessed surfaces include opposing recessed side surfaces, and where the gripping member may be formed as a bar extending from one of the recessed side surfaces to the opposing recessed side surface.

In another embodiment, the recess may include recessed surfaces connected by a recessed back surface which forms a portion of a recessed back wall, wherein the gripping member extends into or through the recessed back wall and extends outwardly from the recessed back surface.

In yet another embodiment, a support wall may be disposed in the hollow body and may extend from an inside surface of the inclined front wheel engaging wall to an inside surface of the inclined back wheel engaging wall.

In still another embodiment, the wheel chock may further include a flat uppermost wall extending between the opposite front and back wheel engaging walls and the opposite upright sidewalls. Further, the support wall may extend downwardly from an internal surface of the flat uppermost wall.

The following description and the annexed drawings set forth certain illustrative embodiments of the invention. These embodiments are indicative, however, of but a few of the various ways in which the principles of the invention may be employed. Other objects, advantages and novel features according to aspects of the invention will become apparent from the following detailed description when considered in conjunction with the drawings.

### BRIEF DESCRIPTION OF THE DRAWINGS

The annexed drawings, which are not necessarily to scale, show various aspects of the invention.

FIG. 1 is a perspective front view of an exemplary wheel chock according to the invention.

FIG. 2 is a schematic front view of the wheel chock of FIG. 1.

FIG. 3 is a cross-sectional side view taken about the line A-A of the wheel chock of FIG. 2.

FIG. 4 is a cross-sectional top view taken about the line B-B of the wheel chock of FIG. 2.

FIG. 5 is a perspective front view of another exemplary wheel chock according to the invention.

FIG. 6 is a schematic front view of the wheel chock of FIG. 5.

FIG. 7 is a cross-sectional side view taken about the line A-A of the wheel chock of FIG. 5.

### DETAILED DESCRIPTION

A wheel chock having a wedge-shaped body and a recessed gripping member is provided. The wedge-shaped body includes a bottom surface for engaging the ground, a front inclined wheel engaging surface, a back surface opposite the front inclined surface, and opposite upright side surfaces. At least one of the opposite upright side surfaces has a recess, and the gripping member is disposed in the recess. The gripping member does not substantially protrude beyond the upright side surface having the recess for enabling an improvement in compact packaging and shipping costs associated with the wheel chock.

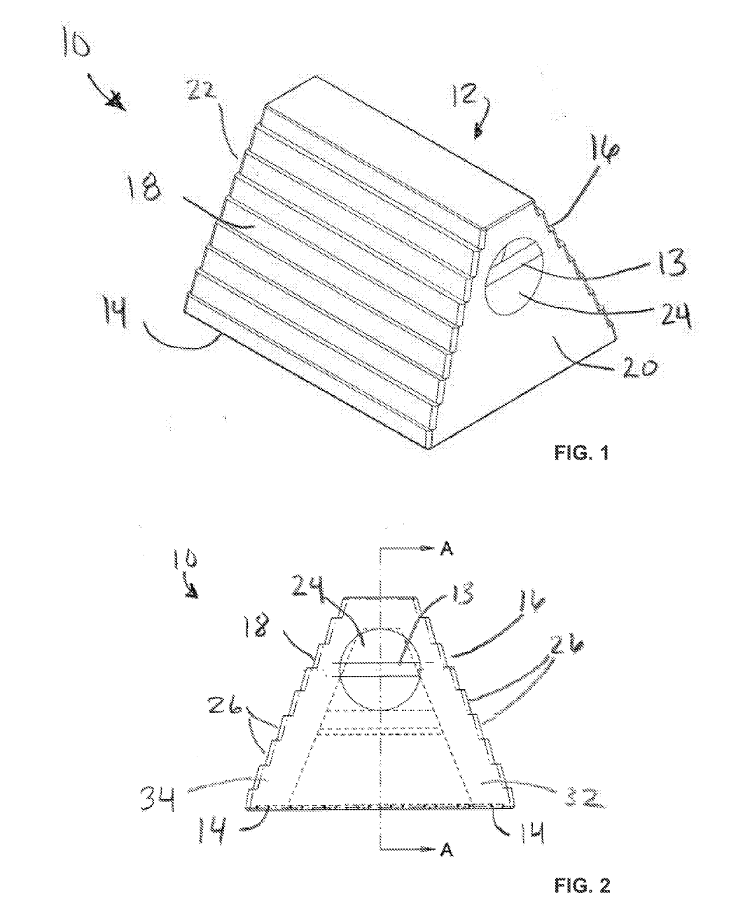

In the discussion above and to follow, the terms “upper”, “lower”, “top”, “bottom,” “front,” “back,” “sides,” “inner,” “outer,” etc. refer to the wheel chock as viewed in a horizontal position, as shown in FIG. 1. This is done realizing that these units, such as when placed on the ground to properly engage a wheel of a vehicle, can be shipped or arranged in various other positions.

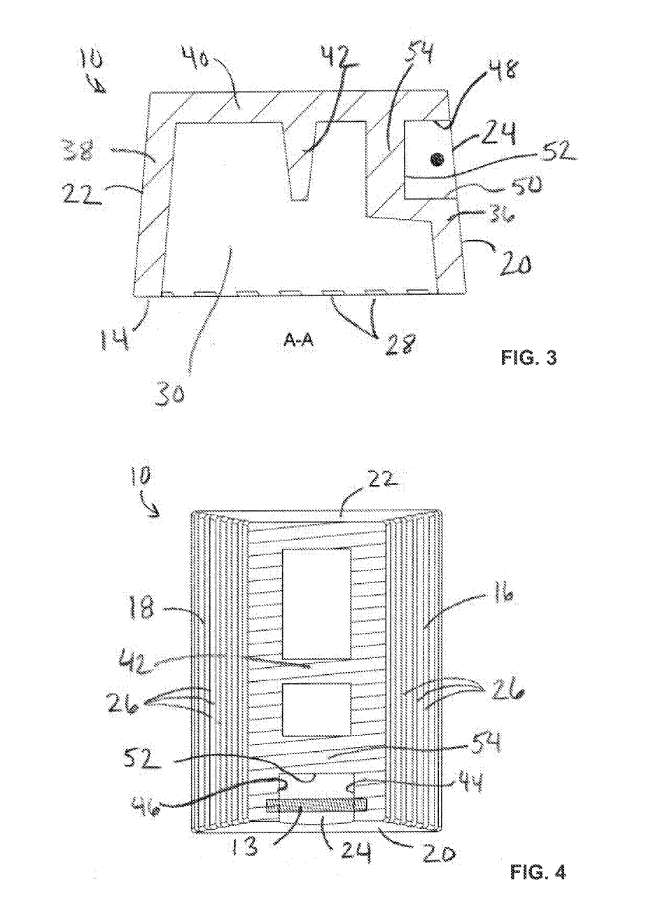

Turning now to FIGS. 1-4, an exemplary wheel chock 10 is shown, including a wedge-shaped body 12 and a gripping member 13. The wedge-shaped body includes a bottom surface 14, a front inclined wheel engaging surface 16, a back surface 18, and opposite upright side surfaces 20, 22.

The front inclined surface 16 extends upwardly from the bottom surface 14, and may be inclined to a plane that is perpendicular to the bottom surface 14 or ground. The front inclined surface 16 may be configured for engaging the wheel of a vehicle, and may include a plurality of traction members 26 for enabling improved engagement and traction with the wheel. The traction members 26 may be steps, ridges, treads, grooves, recesses, and/or protrusions, and may cover some or most of the front inclined surface 16. The front inclined surface 16 may be configured relatively straight and continuous along an inclined plane, or the front inclined surface 16 may be curved and correspondingly configured to complement the shape of the wheel. The front inclined surface 16 may be configured with various other angles or curvatures for engaging the wheel, or otherwise.

The back surface 18 is opposite the front inclined surface 16 and extends upwardly from the bottom surface 14. The back surface 18 may be oriented perpendicular to the bottom surface 14, or the back surface 18 may be inclined to a plane that is perpendicular to the bottom surface 14, as shown. By providing an inclined back surface 18 that is inclined opposite to the front surface 16, the stability of the wheel chock 10 may be enhanced when the force from the wheel acts against the wheel chock 10. The back surface 18 may be configured similar to or the same as front inclined surface 16. As such, the back surface 18 may also have traction members 26 and/or may be configured straight, curved, or have various other configurations.

The upright side surfaces 20, 22 are opposite to each other, and each upright side surface 20, 22 extends upwardly from the bottom surface 14. Each upright side surface 20, 22 also extends between the front inclined surface 16 and the back surface 18, which improves the structural stability of the wheel chock 10. The upright side surfaces 20, 22 may be perpendicular to the bottom surface 14, or the upright side surfaces may be inclined to a plane perpendicular to the bottom surface 14. The incline of upright side surfaces 20, 22 may be a relatively slight incline, such as being less than the incline of the front surface 16 and/or back surface 18, so as to improve stability and stress distribution of the wheel chock 10, and also to minimize the footprint of the wheel chock 10. As will be described in further detail below, at least one of the upright side surfaces 20, 22 include a recess 24 in which the gripping member 13 is disposed.

The bottom surface 14 is configured for engaging the ground or floor and may include traction members 28, such as grooves, treads, recesses and/or protrusions for enabling improved traction with the ground. The bottom surface 14 may continuously extend between the front inclined surface 16, back surface 18, and upright side surfaces 20, 22; or the bottom surface 14 may have an opening or openings for accessing an internal hollow or chamber 30 of the wheel chock 10.

By providing a hollow wedge-shaped body 12, the overall mass of the wheel chock 10 may be reduced for improving transportability and shipping costs associated with the wheel chock 10. To maintain the structural integrity of the wheel chock 10 as the wheel exerts force on the wheel chock 10, the wheel chock 10 may be formed by walls having a suitable thickness to provide the requisite strength and rigidity (e.g., preventing plastic deformation), which may depend on the material selected for the wheel chock 10. In this manner, the wheel chock 10 may include an inclined front wall 32 and an opposite inclined back wall 34, each having a bottom surface 14 and respective outer surfaces 16, 18. The wheel chock 10 also includes opposite upright sidewalls 36, 38, each extending between the front wall 32 and back wall 34, wherein the respective opposite upright sidewalls 36, 38 each have a bottom surface 14 and respective outer side surfaces 20, 22. The wheel chock 10 may also include an uppermost wall 40 that extends between the front wall 32 and back wall 24, and extends between the upright sidewalls 36, 38. To further improve the structural stability of the wheel chock 10, a support wall 42 may be disposed in the hollow body 12 and may extend from an inside surface of the inclined front wall 32 to an inside surface of the inclined back wall 34. The support wall 42 may also extend downwardly from an internal surface of the flat uppermost wall 40, and may be centrally located where forces from the wheel are likely to be greatest.

As mentioned above, the wheel chock 10 includes a gripping member 13. The gripping member 13 is provided for enabling manipulation of the wheel chock 10, such as attaching the wheel chock 10 to a rope or cable, or for grasping the wheel chock 10 by hand. The manipulation of the wheel chock 10 enables the user to transport the wheel chock 10 and to safely secure the wheel chock 10 against the wheel of a vehicle. The gripping member 13 may also enable the wheel chock 10 to be connected to another similar wheel chock with a rope or cable to provide a combined wheel chock pair.

Still referring to FIGS. 1-4, the gripping member 13 is disposed in a recess 24 of the upright side surface 20 for enabling improvements in compact packaging and/or shipping costs associated with the wheel chock 10. So as to enable the improved packaging of the wheel chock 10, the gripping member 13 preferably does not protrude beyond the upright side surface 20 having the recess 24. More particularly, the gripping member 13 may be configured to not outwardly protrude beyond the upright side surface 20, or may be configured to not substantially protrude beyond the upright side surface 20, such as protruding less than 0.5 inches beyond the upright side surface 20, preferably no more than 0.25 inches, and even more preferably less than 0.125 inches. Such a configuration of the gripping member 13 disposed in the recess 24 enables the wheel chock 10 to take up less packaging space and may reduce damage to the shipping box, thus benefiting the distributors and retailers of such wheel chocks 10.

By locating the recess 24 and gripping member 13 on the upright side 20 of the wheel chock 10, the user may safely secure the wheel chock 10 against the wheel of a vehicle without placing their body in front of the vehicle. In addition, locating the recess 24 and gripping member 13 on the upright side 20 also enables the wheel chock 10 to have a back surface 18 configured as an inclined wheel engaging surface that is similar to the opposite front inclined wheel engaging surface 16. Providing opposite inclined wheel engaging surfaces 16, 18 with the recessed gripping member 13 on the side 20 may improve stability of the wheel chock 10, as discussed above, as well as provide a less orientation-dependent wheel chock 10. It should be understood, that multiple recesses 24 and gripping members 13 may be used on one or multiple sides 20, 22 of the wheel chock 10 in the manner described above.

The recess 24 may also help to protectively shroud the gripping member 13 from ice or contaminants when the wheel chock 10 is used in harsh environments. In this manner, the recess 24 may include recessed surfaces extending inwardly from the upright side surface 20 and being configured to surround the gripping member 13. The recessed surfaces may include opposing recessed side surfaces, such as opposing lateral recessed side surfaces 44 and 46, and opposing upper and lower recessed side surfaces 48 and 50. The lateral recessed side surfaces 44, 46 are adjacent to and connect with the upper recessed side surface 48 and lower recessed side surface 50. A recessed back surface 52 may also be provided, which connects with the respective recessed side surfaces 44, 46, 48 and 50; and which also forms a portion of a recessed back wall 54. The recess 24 in the upright side surface 20 may have various configurations, such as dish-shaped, paraboloid, hemispherical, cuboid, prismatic, pyramidal, cylindrical, conical, and frustum-shaped. For example, the recess 24 may be cylindrical or prismatic having a maximum upper-to-lower recessed side length between 1 inch to 6 inches, a maximum recessed side-to-side width between 1 inch to 6 inches, and a recessed depth between 1 inch to 3 inches, which may provide sufficient spacing to enable a person to grip the gripping member 13 and/or wheel chock 10 with a finger hold, or provide sufficient spacing to loop a cable or hook around the gripping member 13.

The gripping member 13 may be provided in various configurations and may be operatively connected to the wheel chock body 12 in any suitable manner. For example, the gripping member 13 may be attached to the wheel chock body 12 by threading, fastening, and/or adhering. The wheel chock body 12 may be formed around the gripping member 13, or the gripping member 13 may be integrally formed and unitary with the wheel chock body 12. For example, as shown in FIGS. 1-4, the gripping member 13 may be configured as a bar that extends from one recessed side surface, such as the lateral recessed side surface 44, to the opposing recessed side surface, such as the opposing lateral recessed side surface 46. The gripping member 13 may extend into the respective recessed side surfaces 44, 46 for securing the gripping member 13 to the wheel chock body 12. The gripping member 13 may be spaced from the respective adjacent recessed side surfaces, such as the opposing upper and lower recessed side surfaces 48, 50, and may also be spaced from the recessed back surface 52 for enabling sufficient spacing to grip the bar and to manipulate the wheel chock 10. It should also be understood that the gripping member 13 may be oriented in various manners within the recess 24, such as extending from the upper recessed side surface 48 to the lower recessed side surface 50, or otherwise.

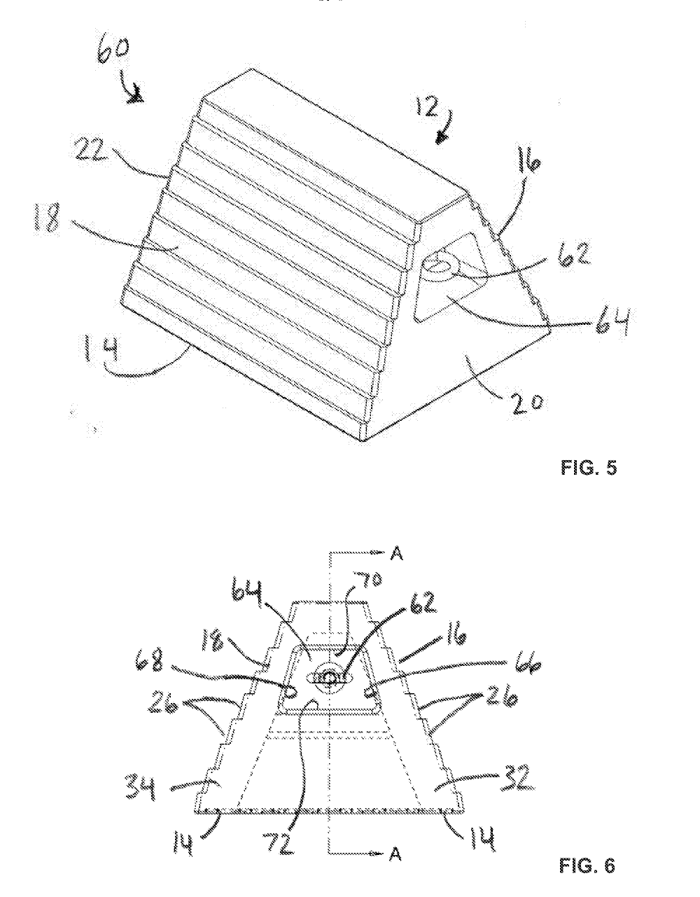

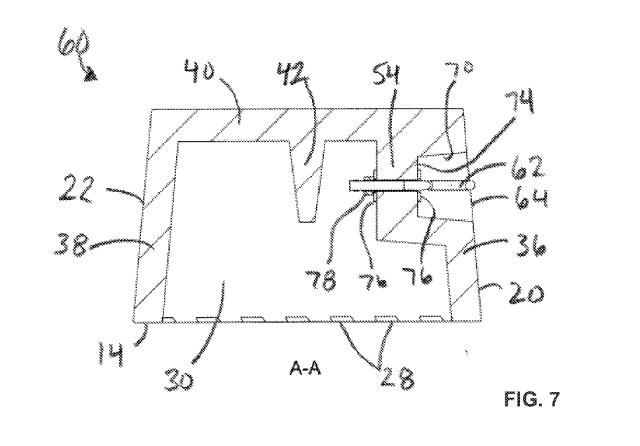

Turning now to FIGS. 5-7, another exemplary embodiment of a wheel chock 60 is shown. The wheel chock 60 is substantially the same as the above-referenced wheel chock 10, and consequently the same or similar reference numerals are used to denote the same or similar structures. In addition, the foregoing description of the wheel chock 10 is equally applicable to the wheel chock 60, except as noted below. Moreover, it will be appreciated upon reading and understanding the specification that aspects of the wheel chocks 10, 60 may be substituted for one another or used in conjunction with one another where applicable.

The wheel chock 60 includes a wedge-shaped body 12 and a gripping member 62 disposed in a recess 64. The recess 64 has a trapezoidal opening in the upright side surface 20, and includes opposing recessed side surfaces, such as lateral recessed side surfaces 66 and 68, and upper and lower recessed side surfaces 70 and 72. The recess also includes a recessed back surface 74 that connects with the respective recessed side surfaces 66, 68, 70, and 72. As with the above-referenced gripping member 13, the gripping member 62 may be provided for enabling improvements in compact packaging and/or shipping costs associated with the wheel chock 60. In this manner, the gripping member 62 preferably does not protrude beyond the upright side surface 20 having the recess 64. More particularly, the gripping member 62 may be configured to not outwardly protrude beyond the upright side surface 20, or may be configured to not substantially protrude beyond the upright side surface 20, as described above with gripping member 13.

The gripping member 62 may be disposed in the recessed back surface 74 and extend outwardly from the recessed back surface 74. The gripping member 62 may be perpendicular to the recessed back surface 74 and extend into or through the recessed back wall 54. The gripping member 62 may be attached to the wheel chock body 12 by threading, fastening, and/or adhering. For example, the gripping member 62 may be attached with washers 76 and a bolt 78. The gripping member 62 may be an eyebolt, u-bolt, ball-head bolt, hook, loop, ring, post, or other fastener.

It should be understood that the gripping members 13 or 62 and wheel chock body 12 may be made of any suitable materials, such as metals, plastics, rubbers and/or composites, which may be selected in a well-known manner to accommodate the forces, abrasion, tractional friction, external environment, size, configuration, assembly, and other factors that would be obvious from the foregoing description. For example, the gripping member 13, 62 may be made of metal, plastic, rubber or other suitable material capable of withstanding the force and abrasion from a cable or other connector. The wheel chock body 12 may be made from plastic, such as rigid thermosets or thermoplastics; or the wheel chock body 12 may be made from elastomeric material, such as rubber-based materials or tire scrap. The wheel chock body 12 may be injection molded as a unitary body, or the respective walls of the wheel chock body may be assembled. The traction members 26 may be formed with the wheel chock body 12, or may be an abrasive material, such as ceramic, that is adhered or attached to the wheel chock body 12.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A wheel chock for placement on the ground to engage a wheel of a vehicle, the wheel chock comprising a wedge-shaped body and a gripping member, said wedge shaped body has:
a bottom surface for engaging the ground;
a front inclined wheel engaging surface extending upwardly from said bottom surface;
a back surface extending upwardly from said bottom surface and being opposite said front inclined surface; and
opposite upright side surfaces each extending upwardly from said bottom surface, said opposite upright side surfaces extending between said front inclined wheel engaging surface and said back surface, wherein one of said opposite upright side surfaces has a recess;
wherein said gripping member is disposed in said recess, and said gripping member does not protrude beyond said upright side surface having the recess.

2. The wheel chock of claim 1, wherein said recess comprises recessed surfaces extending inwardly from said upright side surface, said recessed surfaces including opposing recessed side surfaces, wherein said gripping member is formed as a bar extending from one of said recessed side surfaces to the opposing recessed side surface.

3. The wheel chock of claim 2, wherein said bar is attached to said wheel chock or is integrally formed with said wheel chock.

4. The wheel chock of claim 1, wherein said recess includes recessed surfaces extending inwardly from said upright side surface, said recessed surfaces being connected by a recessed back surface, wherein said gripping member is disposed in said recessed back surface and extends outwardly from said recessed back surface.

5. The wheel chock of claim 4, wherein said gripping member is selected from the group consisting of: eyebolt, u-bolt, ball-head bolt, hook, loop, ring, and post.

6. The wheel chock of claim 4, wherein said gripping member is integrally formed and unitary with the wheel chock.

7. The wheel chock of claim 2, wherein said opposing recessed side surfaces include opposing lateral recessed side surfaces and opposing upper and lower recessed side surfaces,
wherein said respective recessed side surfaces are connected by a recessed back surface,
wherein said bar extends between said opposing lateral recessed side surfaces, and
wherein said bar is spaced from said upper and lower recessed side surfaces and from said recessed back surface for enabling a user to grip the bar for manipulating the wheel chock.

8. The wheel chock of claim 7, wherein said recess has a length between 1 inch to 6 inches, a width between 1 inch to 6 inches, and a depth between 1 inch to 3 inches for enabling a person to grip the bar and/or wheel chock by the recess surfaces.

9. The wheel chock of claim 1, wherein said recess is formed in the shape consisting of: dish-shaped, hemispherical, prismatic, pyramidal, cylindrical, conical, and frustum.

10. The wheel chock of claim 1, wherein said front inclined wheel engaging surface has a plurality of traction members for enabling engagement with the wheel.

11. The wheel chock of claim 1, wherein said bottom surface includes grooves, treads, recesses and/or protrusions for enabling engagement with the ground.

12. The wheel chock of claim 1, wherein the other one of said opposite upright side surfaces has a second recess with a second gripping member disposed therein, said second gripping member not protruding beyond the other one of said upright side surfaces.

13. The wheel chock of claim 1, wherein said back surface is an inclined wheel engaging surface comprising traction members for enabling engagement with the wheel.

14. The wheel chock of claim 1, wherein said bottom surface has an opening for accessing an internal hollow of said wheel chock.

15. A wheel chock for placement on the ground and being engageable with a wheel, the wheel chock comprising a gripping member and a hollow wedge-shaped body, said body being formed by walls including:
opposite inclined front and back wheel engaging walls each having a bottom surface for engaging the ground and an inclined surface for engaging the wheel; and
opposite upright sidewalls extending between said opposite front and back wheel engaging walls, said opposite upright sidewalls each having a bottom surface and an outer side surface,
wherein one of said opposite upright sidewalls has a recess and said gripping member is disposed in said recess, said gripping member not substantially protruding beyond the outer side surface of said opposite upright sidewall having the recess.

16. The wheel chock of claim 16, wherein said recess comprises recessed surfaces including opposing recessed side surfaces, wherein said gripping member is formed as a bar extending from one of said recessed side surfaces to the opposing recessed side surface.

17. The wheel chock of claim 16, wherein said recess includes recessed surfaces connected by a recessed back surface, wherein said gripping member is disposed in said recessed back surface and extends outwardly from said recessed back surface.

18. The wheel chock of claim 16, wherein a support wall is disposed in the hollow body and extends from an inside surface of the inclined front wheel engaging wall to an inside surface of the inclined back wheel engaging wall.

19. The wheel chock of claim 18, further comprising a flat uppermost wall extending between said opposite front and back wheel engaging walls and said opposite upright sidewalls; wherein said support wall extends downwardly from an internal surface of the flat uppermost wall.
